(19) United States
(12) Patent Application Publication
(10) Pub. No.: US 2006/0284340 A1
(43) Pub. Date: Dec. 21, 2006

(54) Method for preventing the overflowing of molding compound during fabricating package device

(75) Inventors: Chun-Tiao Liu, (US); Da-Jung Chen, Taoyuan (TW); Jeng-Jen Li, (US); Chun-Liang Lin, Liu-Ying Hsiang (TW); Chau Chun Wen, Taoyuan (TW)

Correspondence Address: Genus Law Group PLLC;Raymond J. Ho; David B. Dort, Box 26219, Crystal City Station, Arlington, VA, 22215, US

(73) Assignee: CYNTEC CO., LTD.

(21) Appl. No.: 11/192,651

(22) Filed: Jul. 29, 2005

(30) Foreign Application Priority Data
Jun. 17, 2005 (TW) 094120263

(51) Int. Cl. B29C 45/14

(52) U.S. Cl. 264/272.11; 264/272.15; 425/116

(57) ABSTRACT

A method for preventing the overflowing of the molding compound is disclosed. The method provides a substrate that having at least a pair of outer leads. By the pressed downward the pair of outer leads as the thimble point, the substrate can contact with the mold completely without any gap therebetween, thus, the overflowing of the molding compound would not be occurred.

### BACKGROUND OF THE INVENTION

1. Field of the Invention

The present invention generally relates to a method for forming a package device, and more particularly to a method for preventing the overflowing of the molding compound of the package device.

2. Description of the Prior Art

In generally, the major fabricating process for the ball grid array (BOA) type semiconductor package device is that the chip is adhered on the substrate, and is electrically coupled with the substrate by way of the wire bond. Then, the substrate is placed into the mold. Next, the molding process is performed to substrate with the chip thereon, such that the chip is encapsulated by the molding compound. Thereafter, the metal ball and the bonding pad are formed on the bottom surface of the substrate with the chip thereon after the molding compound is solidified, and then the substrate is sawed to obtain a semiconductor package device.

However, the inaccuracy would be occurred during the combining the top mold with the bottom mold. Therefore, there is a slit in the junction between the top mold and the substrate. Thus, the several molding compound would be overflowed from the mold cavity and flowed into the slit between the top mold and the substrate to make the overflowed molding compound is adhered on the substrate or the top mold when the molding compound is pressurized and is filled into the mold cavity.

Because the flowed-out encapsulant material is adhered on the substrate, and the shape can not approved by the quality control of the semiconductor device. Thus, the several modified process would be performed for the semiconductor device. Therefore, the steps for the fabricating process would be increased and the cost is also increased. In addition, the cutting tools would be damaged the surface of the substrate to decrease the yield of the semiconductor device when the cutting tools is used to remove the molding compound that is adhered on the surface of the substrate.

On the other hand, the conventional technology also provided a method for preventing the overflowing of the molding compound, which includes a substrate within a semiconductor package structure, a cofferdam, a chip, a plurality of solder balls, a plurality of conductive wires on the surface of the substrate, and a plurality of bonding pads. The cofferdam is formed from a lead-frame and is adhered on the top surface of the substrate, which corresponds to the window of the surface of the substrate to prevent the overflowing of the molding compound. The chip is adhered on the substrate, the plurality I/O bonding pads is formed on the center of the chip surface, and on the window of the substrate. The plurality of conductive wires used to electrically couple the substrate and the plurality of I/O bonding pads. The plurality of solder balls is placed on the each of the plurality of bonding pads, which is electrically coupled with the outside. The cofferdam is added extra on the surface of the substrate and prevented the overflowing of the molding compound, but the fabricating process for forming the cofferdam on the substrate is more difficulty in the semiconductor package device fabrication.

### SUMMARY OF THE INVENTION

The aspect of the present invention is to provide the substrate has the outer leads on the periphery of the substrate as the thimble point, and is pressed downward the thimble point to let the substrate is contacted with the mold completely, thus there is no gap between the substrate and the mold. Therefore, the overflowing of the molding compound is not occurred after molding process.

According to above aspect, the present invention provides a method for preventing the overflowing of molding compound. The method includes providing a substrate having a plurality of outer leads, a chip is formed on the substrate, and the plurality of wirings is electrically coupled the substrate with the chip. Then, a mold is consisted of a top mold and a bottom mold. The size of the top mold cavity and the bottom mold cavity can contain the substrate. Next, the substrate is placed into the bottom mold, such that the plurality of outer leads is exposed out of the periphery of the substrate. Then, a molding process is performed to combine the top mold and the bottom mold. Next, the thimble point is pressed downward by the thimble point to let the substrate is contacted with the mold completely. Then, a molding compound is filled into the substrate and the mold, and there is no gap to let the molding compound is flowed into the substrate and the bottom mold. Thus, the overflowing of the molding compound is not occurred after the molding process.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a flow diagram showing the steps for preventing the overflowing of the molding compound in accordance with the method disclosed herein; and

FIG. 2A to FIG. 2B are schematic representations of the method for preventing the overflowing of the molding compound in accordance with the method disclosed herein.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

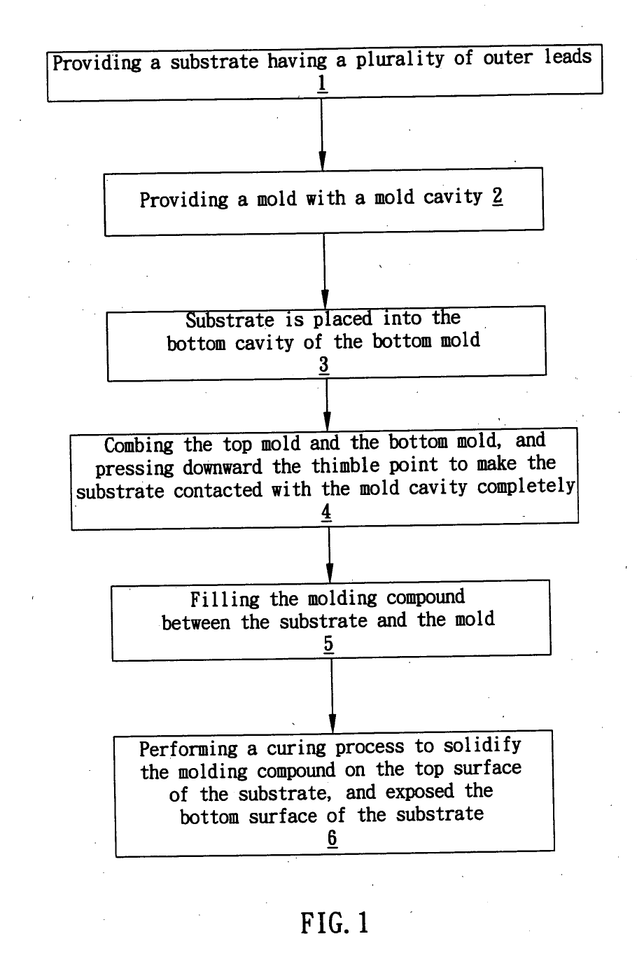

Referring to FIG. 1, the flow diagram shows the method for preventing the overflowign of the molding compound of the present invention. Step 1 illustrates the providing a substrate having a plurality of outer leads. Step 2 illustrates a mold with a cavity. Step 3 illustrates the substrate that is placed into the bottom mold cavity, and the plurality of outer leads is exposed out of the periphery of the substrate. Then, step 4 denotes the top mold is combined with the bottom mold, and the thimble point is pressed downward to make the substrate and the mold is contacted completely. Next, in step 5, the molding compound is filled into the mold cavity between the substrate and the mold. Because the substrate is contacted with the mold completely, then the molding compound cannot overflow into the gap between the substrate and the mold. Thus, the overflowing of the molding compound would be occurred. Finally, a curing process is performed to the substrate to solidify the molding compound on the sop surface of the substrate, and exposed the bottom surface of the substrate to finish the package process.

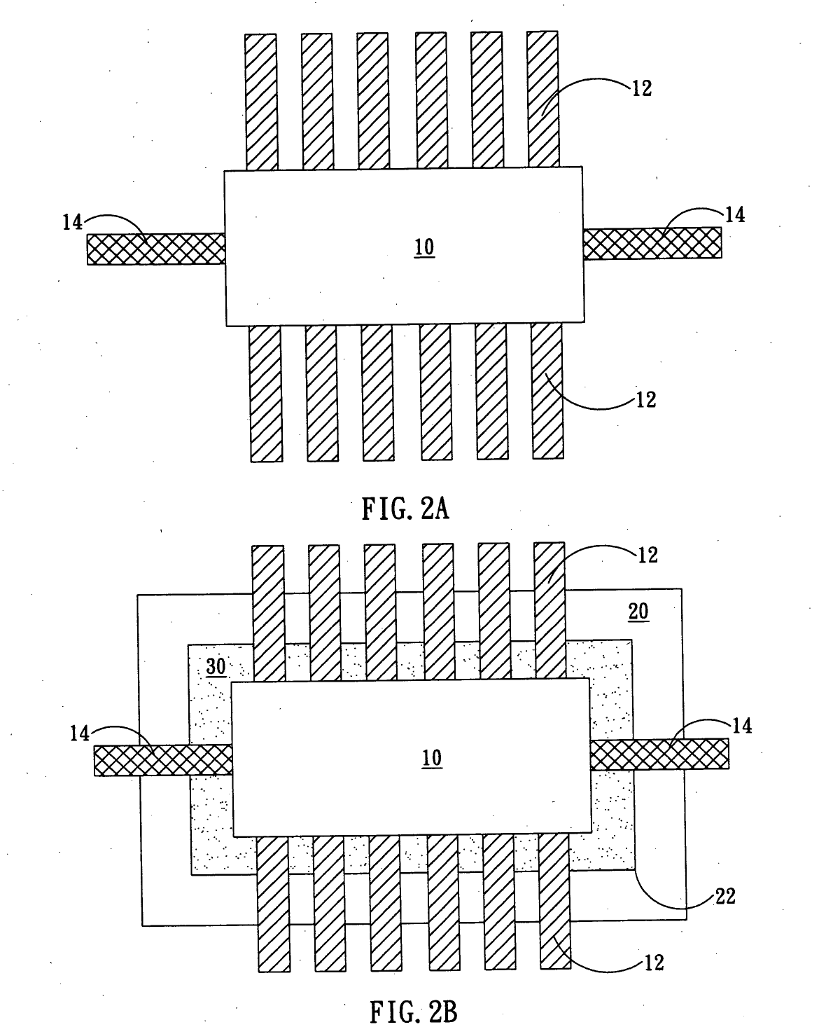

FIG. 2A to FIG. 2B is a schematic representation the steps for preventing the overflowing of the molding compound that according to the flow diagram of FIG. 1. Firstly, referring to FIG. 2A, which is a vertical view for the substrate having a plurality of pins. The substrate 10 further includes a chip (not shown), wherein the chip can be a wire bond chip or a flip chip. If the chip is wire bond chip, the chip is electrically coupled with the substrate 10 by way of the plurality of wirings (not shown). If the chip is a flip chip, which is electrically coupled with the substrate 10 by way of the plurality of solder bumps.

Furthermore, the substrate further includes a pair of outer leads or a plurality of outer leads 12. The plurality of outer leads 12 is made of the lead-frame. Otherwise, these lead-frames 12 also can be formed by way of the unity method with the substrate 10. The plurality of outer leads 12 is not only used to electrically couple with the electronic device, but also used as the thimble point 14 of the substrate 10 which is contacted with the mold. When the plurality of outer leads on the outside of the substrate is pressed downward by the thimble, the substrate 10 is contacted with the bottom mold cavity 22 of the bottom mold 20 completely. That is to say, there is no gap between the substrate 10 and the bottom mold cavity 22. Thus, the molding compound cannot overflow between the substrate and the bottom mold cavity in subsequent molding processes. Therefore, the inequality pressure to press the thimble point, different size of the raw materials or inaccuracy of the manufacturing would not be introduced the overflowing of the molding compound.

Moreover, the material of the plurality of outer leads 12 and the thimble point 14 is made of the metal plate or the metal block, or is made of the nonmetallic materials. It should be noted that the material of the substrate 10 can be dielectric material, insulating material, or is selected from the group consisting of the composite material of metal, a single surface with the composite material of a metal and double surface with the composite material of a metal.

Then, referring to FIG. 2B, it is noted that the real line denotes the bottom mold cavity 22 which contains the substrate 10. Thus, the size of the bottom mold cavity 22 can correspond to the size of the substrate 10.

Then, it is the key feature of the present invention. A molding process is performed to combine the top mold and the bottom mold 20, and the thimble is pressed downward the plurality of outer leads 12 of the substrate 10 simultaneously, such that the substrate 10 is contacted with the bottom mold cavity 22 of the bottom mold 20 completely. Thus, there is no gap between the substrate 10 and the bottom mold cavity 22. Therefore, the molding compound 30 cannot overflow between the substrate 10 and the bottom mold cavity in subsequent molding processes. The molding compound 30 only formed between the surface of the substrate and the top mold. Accordingly, the oevrflowing of the molding compound 30 would not be occurred. The molding compound 30 can be an insulating thermosetting composite material, such as silica filler material or epoxy.

Finally, a curing process is performed to the substrate 10 with the chip to thermosetting the molding compound 30. Thus, the top surface and the periphery of the substrate 10, and the electronic device on the substrate 10 are encapsulated by the molding compound 30. Because there is no gap between the substrate 10 and the bottom mold cavity 22, the molding compound 30 is not covered the bottom of the substrate 10 to expose the bottom surface of the substrate 10.

Although specific embodiments have been illustrated and described, it will be obvious to those skilled in the art that various modifications may be made without departing from what is intended to be limited solely by the appended claims.

What is claimed is:

1. A method for preventing the overflowing of the molding compound, said method comprising:
providing a substrate, said substrate having a plurality of outer leads;
providing a mold has a mold cavity therein, said mold having a top mold and a bottom mold, and said mold cavity can contain said substrate;
placing said substrate into a bottom cavity of said bottom mold;
performing a molding process to combine said top mold and said bottom mold;
pressing downward said plurality of said outer leads of said substrate, such that said substrate contacted with the said bottom mold completely, and there is no gap between said substrate and said bottom mold cavity; and
filling a molding compound between said substrate and said mold, wherein said molding compound covered between said top mold and a top surface of said substrate, and the periphery of said substrate.

2. The method according to claim 1, wherein the material of said substrate is selected from the group consisting of a dielectric material and an insulating material.

3. The method according to claim 1, wherein the material of said substrate is selected from the group consisting of the composite material of metal, a single surface with the composite material of a metal, and double surface with the composite material of a metal.

4. The method according to claim 1, further comprising a chip on said substrate.

5. The method according to claim 4, wherein said chip is electrically coupled with said substrate by way of a plurality of conductive wires.

6. The method according to claim 4, wherein said chip is electrically coupled with said substrate by way of a plurality of solder bumps.

7. The method according to claim 1, wherein the material of said plurality of outer leads is selected from the group consisting of a lead-frame, and a lead-frame is formed by the unity method with said substrate.

8. The method according to claim 1, wherein said molding compound is an insulating thermosetting composite material.

9. The method according to claim 8, wherein the material of said insulating thermosetting composite material is selected from the group consisting of epoxy, and silica filler material.

10. A structure for preventing the overflowing of the molding compound, said structure comprising:
a mold having a top mold with a top mold cavity and a bottom mold with a bottom mold cavity; and
a substrate having a plurality of outer leads on said periphery of said substrate, and said substrate contacted with said bottom mold cavity completely, such that there is no gap between said substrate and said bottom mold cavity.

11. The structure according to claim 10, wherein the material of said plurality of outer leads is selected from the group consisting of a lead-frame, and a lead-frame is formed by unity method with said substrate.

12. A method for preventing the overflowing of the molding compound of a package device, said method comprising:
providing a substrate, said substrate having a pair of thimble point on two sides of said substrate;
providing a mold with a mold cavity, said mold having a top mold and a bottom mold, and said mold cavity can contain said substrate;
placing said substrate within a bottom mold cavity of said bottom mold, and said pair of thimble point of said substrate is exposed outside of said bottom mold;
performing a molding process to combine said top mold and said bottom mold;
pressing downward said pair of thimble point to make said substrate contacted with the said bottom mold completely, and there is no gap between said substrate and said bottom mold cavity;
filling a molding compound into between said substrate and said mold; and
curing said molding compound covered a top surface of said substrate and said periphery of said substrate, and exposed a bottom surface of said substrate.

13. The method according to claim 12, wherein the material of said substrate is selected from the group consisting of a dielectric material and an insulating material.

14. The method according to claim 12, wherein the material of said substrate is selected from the group consisting of the composite material of metal, a single surface with the composite material of a metal, and double surface with the composite material of a metal.

15. The method according to claim 12, wherein the material of said pair of said thimble point is selected from the group consisting of a lead-frame, and a lead-frame is formed by the unity method with said substrate.

16. The method according to claim 12, wherein the material of said molding compound is an insulating thermosetting composite material.

17. The method according to claim 16, wherein the material of said insulating thermosetting composite material is selected from the group consisting of epoxy and a silica filler material.
